(19) United States
(12) Patent Application Publication
(10) Pub. No.: US 2019/0310414 A1
(43) Pub. Date: Oct. 10, 2019

(54) LIQUID CRYSTAL DISPLAY DEVICE

(71) Applicant: SHARP KABUSHIKI KAISHA, Osaka (JP)

(72) Inventor: OSAMU ITOH, Sakai City (JP)

(21) Appl. No.: 16/374,230

(22) Filed: Apr. 3, 2019

(30) Foreign Application Priority Data
Apr. 6, 2018 (JP) 2018-073702

(51) Int. Cl. F21V 8/00

(52) U.S. Cl. CPC G02B 6/0088; G02B 6/009

(57) ABSTRACT

A liquid crystal display device includes a liquid crystal panel and a lighting device including a light source, a light guide plate having a light exit surface, an optical sheet including films on the light exit surface and configured to exert optical effects on the light from the light exit surface, and a tray-like bezel holding the light source, the light guide plate, and the optical sheet. The films of the optical sheet include a panel-side film adjacent to the liquid crystal panel. The panel-side film has an extended portion extending to an outer side surface of the bezel. The panel-side film is attached to the outer side surface of the bezel at at least a portion of the extended portion and is attached to the liquid crystal panel at a surface adjacent to the liquid crystal panel to assemble the liquid crystal panel and the lighting device.

### CROSS REFERENCE TO RELATED APPLICATION

This application claims priority from Japanese Patent Application No. 2018-73702 filed on Apr. 6, 2018. The entire contents of the priority application are incorporated herein by reference.

### TECHNICAL FIELD

The technology described herein relates to a liquid crystal display device.

### BACKGROUND

A liquid crystal display device includes a liquid crystal panel and a lighting device that applies light to a display area of the liquid crystal panel. The lighting device includes, for example, a light source, a light guide plate, an optical sheet that exerts an optical effect on the light from the light guide plate, and a tray-like bezel housing the light source, the light guide plate, and the optical sheet. The liquid crystal panel of the liquid crystal display device is generally attached to the front end of the side wall of the bezel to fix the liquid crystal panel to the lighting device. The optical sheet is also attached to the front end of the side wall of the bezel together with the liquid crystal panel in many cases so as to be positionally fixed.

A liquid crystal display device described in Patent Document 1 includes an optical sheet including a top film that has multiple engaging pieces. The engaging pieces extend from four sides of the film to the rear surface of the bezel (rear chassis) and are attached to the rear surface of the bezel at the front ends. Patent Document 1 describes that the engaging pieces attached to the rear surface of the bezel do not allow the optical sheet to move and eliminates the need for a double-sided adhesive tape that attaches the optical sheet to the liquid crystal panel. The liquid crystal display device in Patent Document 1 avoids including a double-sided adhesive tape that blocks light traveling to the end portion of the liquid crystal panel, such that a non-light emitting area is not generated in the end portion of the liquid crystal panel and light emission intensity does not become non-uniform, in order to achieve a smaller frame width.

[Patent Document 1] Japanese Unexamined Patent Application Publication No. 2016-21356

### SUMMARY

In the lighting device (backlight unit) of the liquid crystal display device described in Patent Document 1, the optical sheet is attached to the rear surface of the bezel. This increases the thickness of the lighting device, resulting in an increase in the thickness of the liquid crystal display device. Furthermore, assembling work of the lighting device of the liquid crystal display device described in Patent Document 1 may be difficult because the work object needs to be turned upside down or the assembling work needs to be done from the rear side of the work object in the production process.

The optical sheet readily expands or contracts with temperature change or humidity change compared with the liquid crystal panel and the bezel. If the optical sheet is attached to the front end of the side wall of the bezel, the optical sheet would be deformed in the display area when expanded or contracted, leading to display unevenness and a display defect in an image displayed on the liquid crystal panel. However, Patent Document 1 does not describe a method of assembling the liquid crystal panel and the lighting device and does not describe how to deal with deformation of the optical sheet.

The technology described herein was made in view of the above circumstances. An object is to provide a liquid crystal display device that is less likely to have display unevenness in the liquid crystal panel, which is caused by deformation of the optical sheet, for example.

To achieve the above-described object, a liquid crystal display device according to the technology described herein includes a lighting device including a light source, a light guide plate to which light from the light source is applied and from which the light exits through a light exit surface that is one of two plate surfaces, an optical sheet including multiple films on the light exit surface of the light guide plate and configured to exert optical effects on the light from the light exit surface, and a tray-like bezel holding the light source, the light guide plate, and the optical sheet, and a liquid crystal panel configured to display an image by using light from the lighting device. The multiple films of the optical sheet include a panel-side film adjacent to the liquid crystal panel and the panel-side film has an extended portion extending to an outer side surface of the bezel and covers the bezel. The panel-side film is attached to the outer side surface of the bezel at at least a portion of the extended portion extending to the outer side surface of the bezel and is attached to the liquid crystal panel at a surface adjacent to the liquid crystal panel to assemble the liquid crystal panel and the lighting device.

If the liquid crystal panel is attached to the front end of the side wall of the bezel as in the above-described known liquid crystal display device, the side wall of the bezel is required to have a large thickness to have a sufficiently large area to be attached to the liquid crystal panel. Contrary to this, the liquid crystal display device having the configuration of the present technology does not require the bezel to have a thick side wall, because the liquid crystal panel is attached to the surface of the panel-side film. This allows a reduction in the frame width. Furthermore, in the liquid crystal display device having the configuration of the present technology, the portion of the panel-side film that extends parallel to the light exit surface of the light guide plate can expand toward the bezel, because the panel-side film is attached to the outer side surface of the bezel. Thus, the panel-side film is less likely to deform in a display area of the liquid crystal panel, leading to a reduction in display unevenness in the liquid crystal panel.

According to the technology described herein, a liquid crystal display device that has a smaller frame width and that is less likely to have display unevenness in the liquid crystal panel, which is caused by deformation of the optical sheet, is provided.

### BRIEF DESCRIPTION OF THE DRAWINGS

FIG. 1 is an exploded perspective view illustrating a television receiver including a liquid crystal display device according to a first embodiment of the technology.

FIG. 2 is a cross-sectional view illustrating the liquid crystal display device according to the first embodiment of the technology taken in the Y axis direction.

FIG. 3 is a cross-sectional view illustrating the liquid crystal display device according to the first embodiment of the technology taken in the Z axis direction.

FIG. 4 is a cross-sectional view illustrating the liquid crystal display device according to the first embodiment of the technology in which an optical sheet is expanded.

FIG. 5 is a cross-sectional view illustrating a liquid crystal display device according to a second embodiment of the technology taken in the Z axis direction.

### DETAILED DESCRIPTION

Hereinafter, some embodiments of the technology will be described in detail with reference to the drawings. The present technology is not limited to the following embodiments. Various modifications and improvements may be made based on knowledge of one skilled in the art.

### First Embodiment

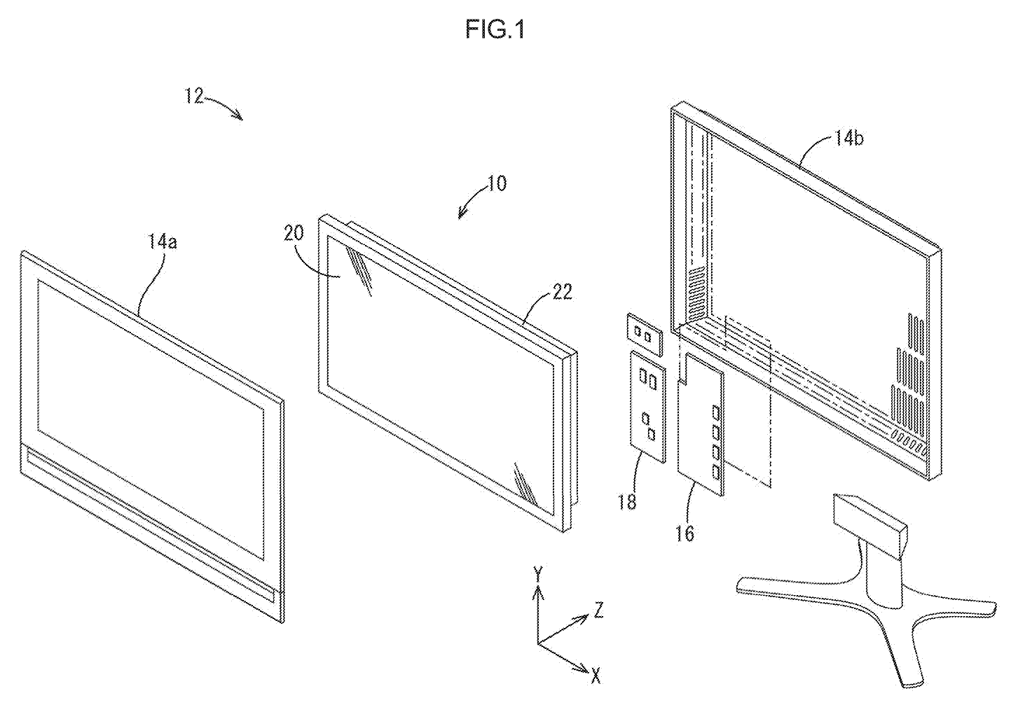

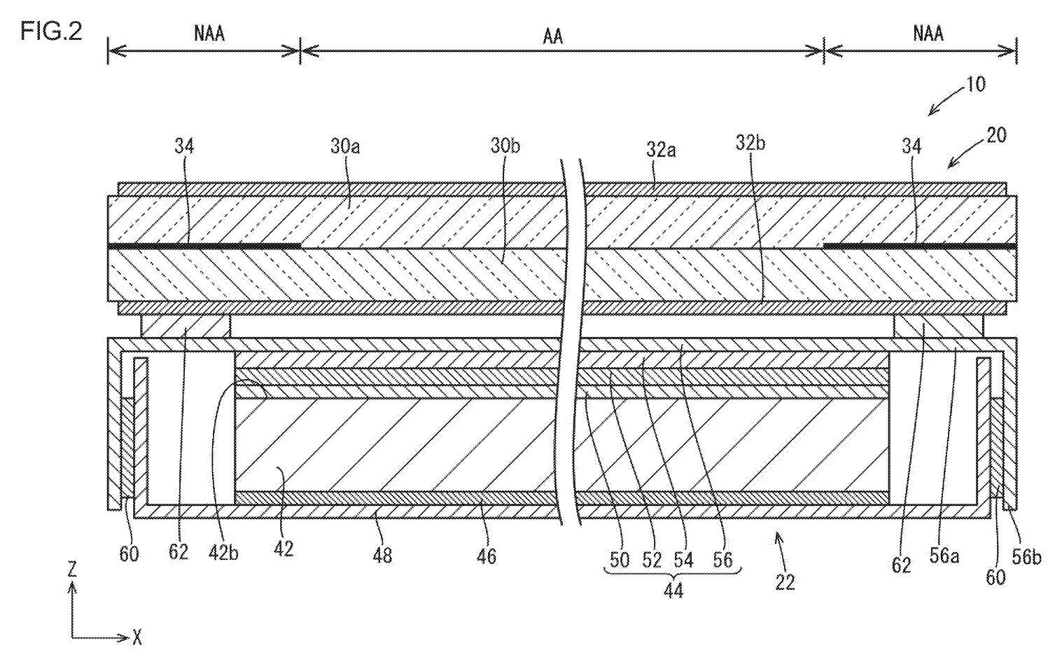

FIG. 1 illustrates a television receiver 12 including a liquid crystal display device 10 according to a first embodiment. The television receiver 12 includes the liquid crystal display device 10, front and rear cabinets 14a and 14b sandwiching and holding the liquid crystal display device 10 therebetween, a power supply 16, and a tuner 18. The X axis, the Y axis, and the Z axis are indicated in some of the drawings, and each of the axes indicates the same direction in the respective drawings. The up and down direction is based on the vertical direction, and the upper side in FIG. 2 is a front side of the liquid crystal display device 10, and the lower side in FIG. 2 is a rear side of the liquid crystal display device 10, unless otherwise specified.

As illustrated in FIG. 2, the liquid crystal display device 10 has a horizontally-elongated rectangular overall shape and includes, as main components, a liquid crystal panel 20, which displays an image thereon, and a backlight device 22, which is a lighting device that applies display light to the liquid crystal panel 20. The liquid crystal panel 20 and the backlight device 22 are assembled. The liquid crystal display device 10 is mounted with the display surface of the liquid crystal panel 20, on which an image is displayed, facing the front side.

The liquid crystal panel 20 includes two substantially transparent substrates 30a and 30b having high light-transmitting properties. One of the substrates 30a and 30b on the upper side (front side) is the CF substrate 30a and the other on the lower side (rear side) is the array substrate 30b. Polarizing plates 32a and 32b are respectively attached to the outer surfaces of the substrates 30a and 30b. In the liquid crystal panel 20, the substrates 30a and 30b are attached to each other with a predetermined gap therebetween. The liquid crystal panel 20 further includes a liquid crystal layer sandwiched between the substrates 30a and 30b and a sealing portion surrounding the liquid crystal layer to seal the liquid crystal layer. The liquid crystal layer includes liquid crystal molecules, which are substances whose optical properties are changed by application of an electrical field.

The internal structure of the liquid crystal panel 20 is briefly described. The components of the internal structure are not illustrated. TFTs (Thin Film Transistor), which are switching devices, and pixel electrodes are arranged in a matrix (rows and columns) on the inner surface of the array substrate 30b. Gate lines and source lines are routed in a grid on the inner surface of the array substrate 30b to surround the TFTs and the pixel electrodes. Signals relating to images are sent to the gate lines and source lines. Color filters are disposed on the inner surface of the CF substrate 30a at positions corresponding to the pixel electrodes. The color filters include red (R), green (G), and blue (B) color filters that are alternately arranged. A light blocking portion (black matrix) 34 is disposed on the inner surface of the CF substrate 30a to prevent mixture of colors between adjacent color filters. The light blocking portion 34 has a grid-like shape in a display area AA, which is a middle section of the liquid crystal panel 20, to separate the adjacent color filters. In a non-display area NAA, which is an outer peripheral section of the liquid crystal panel 20, the light blocking portion 34 is solid.

The backlight device 22, which is disposed on the rear side of the liquid crystal panel 20, includes a light source 40, a light guide plate 42 that has a rectangular plate-like shape and guides the light from the light source 40, an optical sheet 44 on the front side of the light guide plate 42, a light reflection sheet 46 on the rear side of the light guide plate 42, and a bezel 48 that supports the light source 40, the light guide plate 42, the optical sheet 44, and the light reflection sheet 46. The backlight device 22 is an edge-lit backlight device in which light from the light source 40 is applied to one side of the light guide plate 42. The light source 40 is disposed on one of two long sides of the backlight device 22.

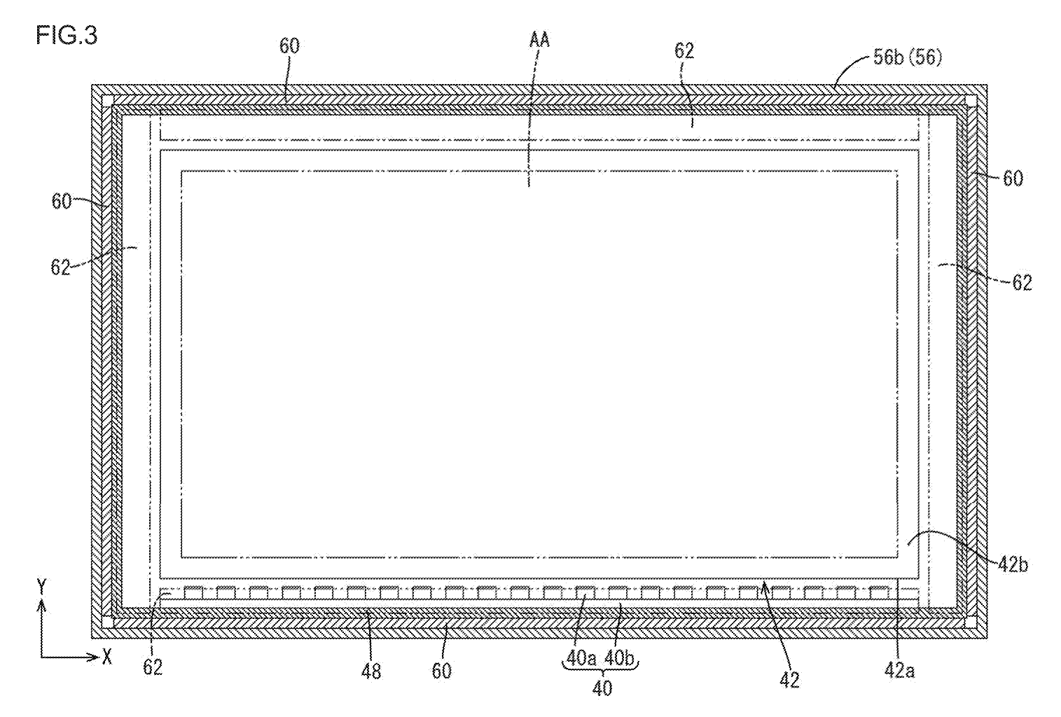

As illustrated in FIG. 3, the light source 40 includes multiple LEDs 40a (Light Emitting Diodes) and an LED board 40b on which the LEDs 40a are mounted. The LEDs 40a each include an LED chip sealed by a sealing material. The LED chip emits monochromatic blue light. The sealing material includes a phosphor (yellow phosphor, green phosphor, or red phosphor, for example) in a dispersed state such that the LED 40a emits white light as a whole. The configuration of the LED 40a is not limited to the above-described configuration and may be changed as necessary. The LED board 40b is a flexible film (sheet) formed of an insulating material. The LEDs 40a are disposed on the LED board 40b at intervals. The LEDs 40a are disposed at regular intervals, but may be disposed at irregular intervals, for example.

The light guide plate 42 is formed of a substantially transparent synthetic resin material (acrylic resin such as PMMA, or polycarbonate, for example), and has a reflectance sufficiently higher than that of air. As illustrated in FIG. 2, one of the four outer side surfaces of the light guide plate 42 is a light-source opposing surface 42a that faces the light source 40. The light-source opposing surface 42a extends straight in a direction in which the LEDs 40a are arranged (see FIG. 3). The outgoing light from the light source 40 enters the light guide plate 42 through a portion of the light-source opposing surface 42a. One of the plate surfaces of the light guide plate 42 that faces the front side (adjacent to the liquid crystal panel 20) is a light exit surface 42b. The light that has traveled in the light guide plate 42 exits through the light exit surface 42b toward the optical sheet 44.

The optical sheet 44 is disposed between the liquid crystal panel 20 and the light guide plate 42. The optical sheet 44 allows the outgoing light from the light guide plate 42 to travel toward the liquid crystal panel 20 while exerting a predetermined optical effect on the outgoing light. The optical sheet 44 includes multiple films disposed one above the other. Specifically described, as illustrated in FIG. 2, the optical sheet 44 in this embodiment includes four sheets: a first diffusing film 50, a first prism film 52, a second prism film 54, and a second diffusing film 56, in this order from the rear side. The first and second diffusing films 50 and 56 each include a substantially transparent base member formed of a synthetic resin and diffusing particles dispersed in the base member to diffuse the light passing therethrough. The first and second prism films 52 and 54 each include multiple prisms extending in one direction on a plate surface of the substantially transparent base member formed of a synthetic resin and selectively focus light in a direction in which the prisms are arranged. The first and second prism films 52 and 54 are positioned such that the prisms in the first prism film 52 and the prisms in the second prism film 54 are perpendicular to each other. The kind or number of films included in the optical sheet 44 may be changed as necessary.

The light reflection sheet 46 has high light reflectance and reflects light leaked from the light guide plate 42 through the plate surface (rear plate surface) opposite the light exit surface 42b to the front side. The bezel 48 is a tray-like metal bezel (aluminum, for example) not having light-transmitting properties. The liquid crystal panel 20 displays an image by using light from the optical sheet 44.

As described above, the liquid crystal display device 10 includes the liquid crystal panel 20 and the backlight device 22 in an assembled state. The structure for assembling the liquid crystal panel 20 and the backlight device 22 is described in detail below. As illustrated in FIG. 2, in the backlight device 22, the second diffusing film 56 as a panel-side film (may be referred to as a “panel-side film 56” in the following description), which is the top film of the optical sheet 44 (adjacent to the liquid crystal panel 20), extends to the outer side surface of the bezel 48. Specifically described, the panel-side film 56 includes a film main portion 56a extending in parallel to the light exit surface 42b of the light guide plate 42 and a vertical portion 56b extending vertically from the outer edge of the film main portion 56a. The panel-side film 56 has a cap-like shape and covers the bezel 48. The panel-side film 56 is attached to the outer side surfaces of the bezel 48 at the vertical portion 56b by a double-sided tape 60 (PET tape, for example). In this embodiment, as illustrated in FIG. 3, the panel-side film 56 and the bezel 48 are attached to each other over the substantially entire perimeter. The backlight device 22 is unitized in this way.

The backlight device 22 formed into one unit as above is attached to the liquid crystal panel 20. Specifically described, the backlight device 22 is attached to the rear surface of the liquid crystal panel 20 at the surface of the panel-side film 56, i.e., the film main portion 56a, by an elastic cushion tape 62 (foamed polystyrene, for example). More specifically described, the cushion tape 62 is disposed in the non-display area NAA of the liquid crystal panel 20 along the outer edge of the film main portion 56a such that the panel-side film 56 and the liquid crystal panel 20 are attached to each other over the substantially entire perimeter as illustrated in FIG. 3. The cushion tape 62 functions as an elastic member. The cushion tape 62 between the panel-side film 56 and the liquid crystal panel 20 elastically deforms to allow relative movement between the surface of the panel-side film 56 to which the cushion tape 62 is attached and the surface of the liquid crystal panel 20 to which the cushion tape 62 is attached, more specifically, to allow parallel relative movement between the surfaces.

The liquid crystal panel 20 and the backlight device 22 are assembled in this way. As described above, since the panel-side film 56 of the optical sheet 44 is extended to the outer side surfaces of the bezel 48 and is attached to the outer side surface of the bezel 48, the front surface of the panel-side film 56 can have an enough area to attach the backlight device 22 to the liquid crystal panel 20. In known liquid crystal display devices, the bezel has the attachment area at the front end of the side wall. For example, in a known liquid crystal display device, a bezel includes a tray-like member formed of a metal and a frame-like member formed of a synthetic resin (polycarbonate, for example). The frame-like member is disposed along the inner side surfaces of the metal member. The frame-like member formed of a synthetic resin has a large thickness to have an enough area to attach the backlight device 22 to the liquid crystal panel 20. Contrary to such a configuration, the liquid crystal display device 10 does not require the frame-like member formed of a synthetic resin. Furthermore, the frame-like member formed of a synthetic resin may have a white surface to function as a member that reflects the light leaked through side surfaces of the light guide plate 42. In such a case, the frame-like member formed of a synthetic resin is able to have a smaller thickness. Accordingly, in the liquid crystal display device 10, the backlight device 22 is smaller and the frame size of the liquid crystal display device 10 is smaller.

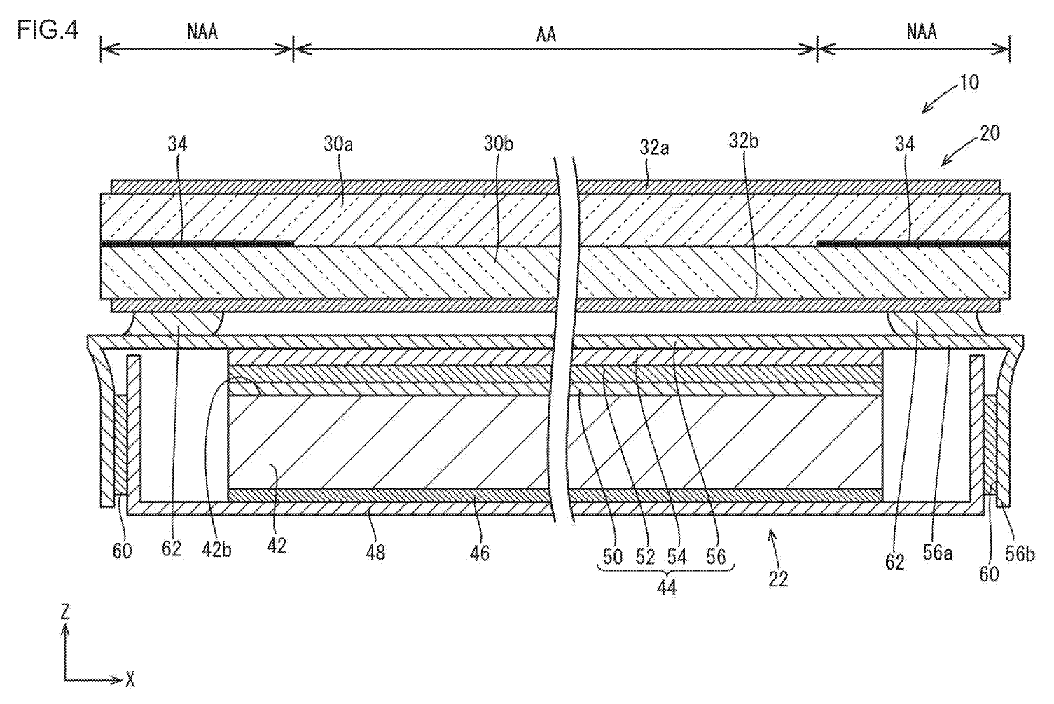

As illustrated in FIG. 2, the panel-side film 56 is attached to the outer side surfaces of the bezel 48 at the front end of the vertical portion 56b by a double-sided tape 60. The base end portion of the vertical portion 56b (adjacent to the film main portion 56a) is not attached to the bezel 48 by the double-sided tape 60. The components of the liquid crystal display device 10 may be expanded when the liquid crystal display device 10 is used at a high temperature or high humidity. The optical sheet 44, which has a high expansion rate, may expand more than the liquid crystal panel 20 and the bezel 48 do. In such a case, as illustrated in FIG. 4, the portion of the vertical portion 56b that is not attached to the bezel 48 deforms. This allows the film main portion 56a to expand. Furthermore, the panel-side film 56 can expand toward the liquid crystal panel 20 because the cushion tape 62 is used to attach the panel-side film 56 to the liquid crystal panel 20. Thus, in the liquid crystal display device 10, the film main portion 56a does not deform in the display area AA, reducing display unevenness and an image defect in the liquid crystal panel 20, which are caused by deformation of the optical sheet 44 in the display area AA.

### Second Embodiment

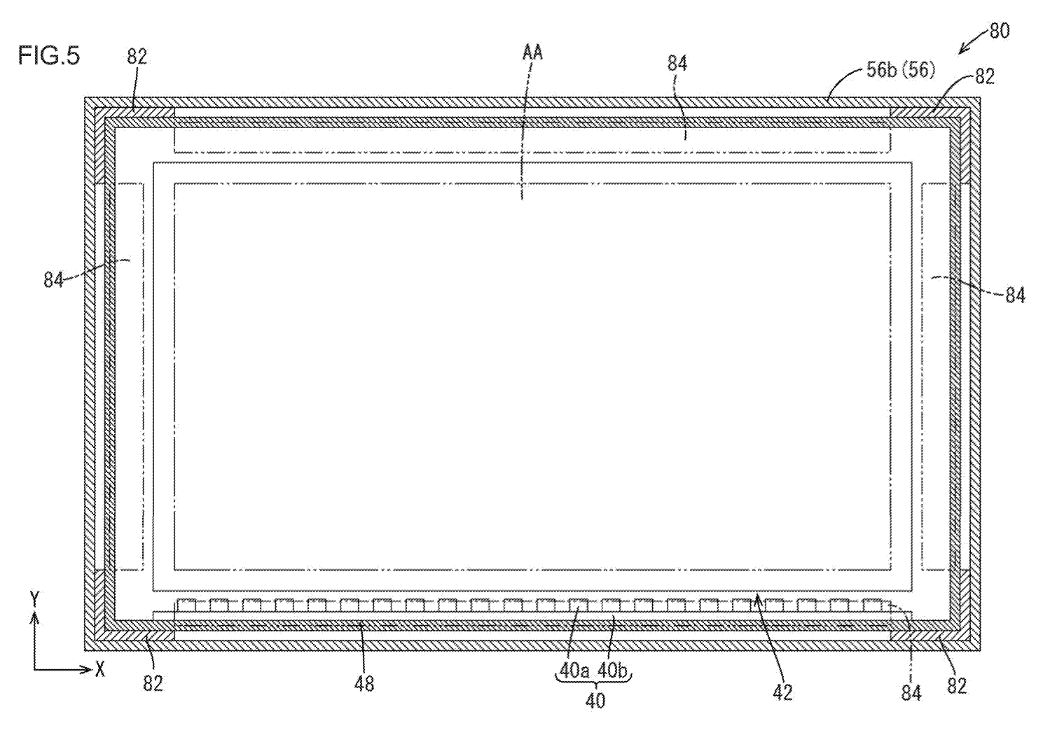

A liquid crystal display device 80 of a second embodiment has substantially the same configuration as that of the liquid crystal display device 10 of the first embodiment. The panel-side film 56 of the optical sheet 44 is attached to the bezel 48 and the liquid crystal panel 20 over different areas from those in the liquid crystal display device 10 of the first embodiment. Hereinafter, the liquid crystal display device 80 of the second embodiment is described in detail with reference to the plan cross-sectional view in FIG. 5. In the description of the liquid crystal display device 80 of the second embodiment, components identical to those of the liquid crystal display device 10 in the first embodiment are assigned the same reference numerals as those in the first embodiment and are not described in detail or are only briefly described.

In the liquid crystal display device 10 of the first embodiment, the panel-side film 56 of the optical sheet 44 is attached to the outer side surfaces of the bezel 48 over the entire perimeter of the bezel 48 and is attached to the outer peripheral portion of the liquid crystal panel 20 over the entire perimeter of the liquid crystal panel 20. In the liquid crystal display device 80 of the second embodiment, as illustrated in FIG. 5, double-sided tapes 82, which attach the panel-side film 56 to the bezel 48, and cushion tapes (elastic member) 84, which attach the panel-side film 56 to the liquid crystal panel 20, do not overlap each other in areas adjacent to the display area AA in directions normal to the sides of the display area AA. In other words, bezel-side attachment portions of the panel-side film 56, which are attached to the bezel 48, and panel-side attachment portions of the panel-side film 56, which are attached to the liquid crystal panel 20, do not overlap each other in areas adjacent to the display areas AA in directions normal to the sides of the display area AA.

Specifically described, only the cushion tapes 84 are disposed in the areas adjacent to the display area AA in the directions perpendicular to the four sides of the display area AA. In other words, in the areas adjacent to the display area AA in the directions perpendicular to the four sides of the display area AA, only the panel-side film 56 and the liquid crystal panel 20 are attached to each other and the panel-side film 56 and the bezel 48 are not attached to each other. In the areas other than the areas adjacent to the display area AA in the directions perpendicular to the four sides of the display area AA, i.e., areas at four corners of the panel-side film 56, only the double-sided tapes 82 are disposed. The panel-side film 56 and the bezel 48 are attached to each other only at the four corners.

In the liquid crystal display device 80 of the second embodiment, the film main portion 56a of the panel-side film 56 does not deform in the display area AA as in the liquid crystal display device 10 of the first embodiment, leading to a reduction in display unevenness and a display defect in an image displayed on the liquid crystal panel 20, which are caused by deformation of the optical sheet 44 in the display area AA. Furthermore, in the liquid crystal display device 80 of the second embodiment, when the panel-side film 56 expands, deformation at the portion attached to the bezel 48 and deformation at the portion attached to the liquid crystal panel 20 do not occur at the same place of the panel-side film 56. This effectively reduces the possibility that the display area AA will be affected by deformation of the panel-side film 56.

<Modifications>

Contrary to the second embodiment, the attachment portions between the panel-side film 56 and the bezel 48 may be attached to each other in the areas adjacent to the display area AA in the directions perpendicular to the four sides of the display area AA and the panel-side film 56 and the liquid crystal panel 20 may be attached to each other in the areas other than the above areas. However, the areas adjacent to the display area AA in the directions perpendicular to the four sides of the display area AA are more likely to have one of the bezel-side attachment portion and the panel-side attachment portion that allows the panel-side film 56 to more readily expand.

In the first and second embodiments, although the liquid crystal panel 20 has a rectangular shape (rectangular display area AA), the liquid crystal panel 20 may have any shape. In a liquid crystal panel having a non-rectangular display area AA, the panel-side attachment portions and the bezel-side attachment portions of the panel-side film 56 do not overlap each other in areas adjacent to the display area in directions normal to an outline of the display area. This effectively reduces the possibility that the display area AA will be affected by deformation of the panel-side film.

1. A liquid crystal display device comprising:
a lighting device including a light source, a light guide plate to which light from the light source is applied and from which the light exits through a light exit surface that is one of two plate surfaces, an optical sheet including a plurality of films on the light exit surface of the light guide plate and configured to exert optical effects on the light from the light exit surface, and a tray-like bezel holding the light source, the light guide plate, and the optical sheet; and
a liquid crystal panel configured to display an image by using light from the lighting device, wherein
the plurality of films of the optical sheet includes a panel-side film adjacent to the liquid crystal panel and the panel-side film has an extended portion extending to an outer side surface of the bezel and covers the bezel, and
the panel-side film is attached to the outer side surface of the bezel at at least a portion of the extended portion extending to the outer side surface of the bezel and is attached to the liquid crystal panel at a surface adjacent to the liquid crystal panel to assemble the liquid crystal panel and the lighting device.

2. The liquid crystal display device according to claim 1, wherein the panel-side film includes a film main portion extending parallel to the light exit surface of the light guide plate and a vertical portion extending from an outer edge of the film main portion in a vertical direction, and
an inner surface of the vertical portion is attached to an outer side surface of the bezel.

3. The liquid crystal display device according to claim 2, wherein the panel-side film is attached to the outer side surface of the bezel at a front end of the vertical portion and is not attached to the outer side surface of the bezel at a base end of the vertical portion.

4. The liquid crystal display device according to claim 1, wherein the panel-side film includes a bezel-side attachment portion attached to the bezel and a panel-side attachment portion attached to the liquid crystal panel, and
the bezel-side attachment portion and the panel-side attachment portion do not overlap each other in an area adjacent to a display area of the liquid crystal panel in a direction normal to an outline of the display area.

5. The liquid crystal display device according to claim 4, wherein the liquid crystal panel and the display area are rectangular, and one of the bezel-panel attachment portion and the panel-side attachment portion is disposed in areas adjacent to the display area in directions perpendicular to four sides of the display area.

6. The liquid crystal display device according to claim 5, further comprising an elastic member between the panel-side attachment portion of the panel-side film and the liquid crystal panel, the panel-side film and the liquid crystal panel being attached to each other by the elastic member, wherein
the panel-side attachment portion is disposed in the areas adjacent to the display area in the directions perpendicular to the four sides of the display area.

7. The liquid crystal display device according to claim 1, further comprising an elastic member between the surface of the panel-side film and the liquid crystal panel, the panel-side film and the liquid crystal panel being attached to each other by the elastic member.
